(19) United States
(12) Patent Application Publication
(10) Pub. No.: US 2025/0139560 A1
(43) Pub. Date: May 1, 2025

(54) USER AUDIT ORCHESTRATION

(71) Applicant: DISNEY ENTERPRISES, INC., Burbank, CA (US)

(72) Inventors: Todd Gregory LARVENZ, Orlando, FL (US); Jeffrey Keith SICKLES, Orlando, FL (US)

(21) Appl. No.: 18/931,950

(22) Filed: Oct. 30, 2024

Related U.S. Application Data
(60) Provisional application No. 63/594,913, filed on Oct. 31, 2023.

(51) Int. Cl. G06Q 10/0639; G06F 16/2453; G06F 21/62

(52) U.S. Cl. CPC G06Q 10/0639; G06F 16/24532; G06F 21/6245

(57) ABSTRACT

The present invention sets forth techniques for performing user audit orchestration. The disclosed techniques include receiving an audit request including at least an application identifier associated with a software application and identifying a plurality of computing resources associated with the application identifier. The techniques also include executing multiple simultaneous queries of the plurality of computing resources, aggregating the results of the multiple simultaneous queries, and generating one or more audit reports based on the aggregated query results of the multiple simultaneous queries.

### CROSS-REFERENCE TO RELATED APPLICATIONS

This application claims priority benefit to the U.S. provisional application titled “USER AUDIT ORCHESTRATION,” filed on Oct. 31, 2023, and having Ser. No. 63/594,913. This related application is also hereby incorporated by reference in its entirety.

### BACKGROUND

### Field of the Various Embodiments

Embodiments of the present disclosure relate generally to enterprise and network computing and, more specifically, to techniques for performing user audit orchestration across a variety of disparate computing resources.

### Description of the Related Art

In the field of enterprise and network computing, organizations must often perform user audits and prepare audit reports based on business software applications, users, and computing resources associated with the organization. For example, an organization may perform a user audit identifying users and computing resources associated with one or more specified business software applications. User audits may be driven by internal requirements specific to the organization, or may be dictated by one or more external compliance requirements, such as requirements specified by the Sarbanes-Oxley Act of 2002 (SOX), the Payment Card Industry (PCI) or the Health Insurance Portability and Accountability Act of 1996 (HIPAA).

Existing techniques for performing user audits may rely on the manual execution of audit processes. For example, software engineering or system security personnel may be required to collect user and application data for all computing resources included in an organization's computing environment. These computing resources may include a large number of disparate computing systems, situated locally on the organization's premises and/or remotely in, e.g., a cloud computing environment.

One drawback to these existing systems is that the manual collection of user, application, and computing resource information is time-consuming and prone to errors. Manual collection is also complicated by variations in data formats and data structures across a wide variety of computing resources. These variations may compromise the integrity and accuracy of collected information. Manual audit data collection also requires specific skills and computing network permissions, which limits the number of personnel within an organization who are both qualified and possess the required permissions to collect user audit information. As a result, manual user audit data collection techniques do not scale to computing environments that may include thousands or tens of thousands of business applications, users, and/or computing resources.

As the foregoing illustrates, what is needed in the art are more effective techniques for performing user audit orchestration across a variety of disparate computing resources.

### SUMMARY

One embodiment of the present invention sets forth a technique for performing user audit orchestration. The technique includes receiving an audit request including at least a business application identifier associated with a business software application, and identifying a plurality of computing resources associated with the business application identifier. The technique also includes executing multiple simultaneous queries of the plurality of computing resources, aggregating results of the multiple simultaneous queries, and generating one or more audit reports based on the aggregated query results of the multiple simultaneous queries.

One technical advantage of the disclosed techniques relative to the prior art is that the disclosed techniques may perform automated user audit orchestration across a variety of disparate computing resources included in an organization's computing environment. The disclosed techniques may further orchestrate multiple user audits or computing resource queries in parallel. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a high-level representation of data flow between various components of the present invention, according to some embodiments.

FIG. 3 is a more detailed illustration of the auditing engine of FIG. 1, according to some embodiments.

FIG. 4 is a flow diagram of method steps for performing user audit orchestration, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

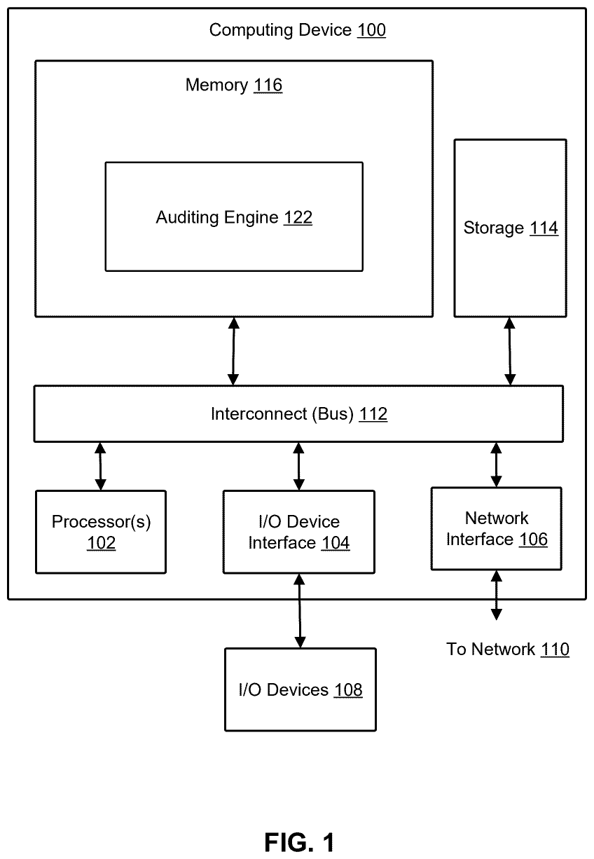

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run an auditing engine 122 that resides in a memory 116.

It is noted that the computing device described herein is illustrative and that any other technically feasible configurations fall within the scope of the present disclosure. For example, multiple instances of auditing engine 122 could execute on a set of nodes in a distributed and/or cloud computing system to implement the functionality of computing device 100. In another example, auditing engine 122, could execute on various sets of hardware, types of devices, or environments to adapt auditing engine 122 to different use cases or applications. In a third example, auditing engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Auditing engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including auditing engine 122.

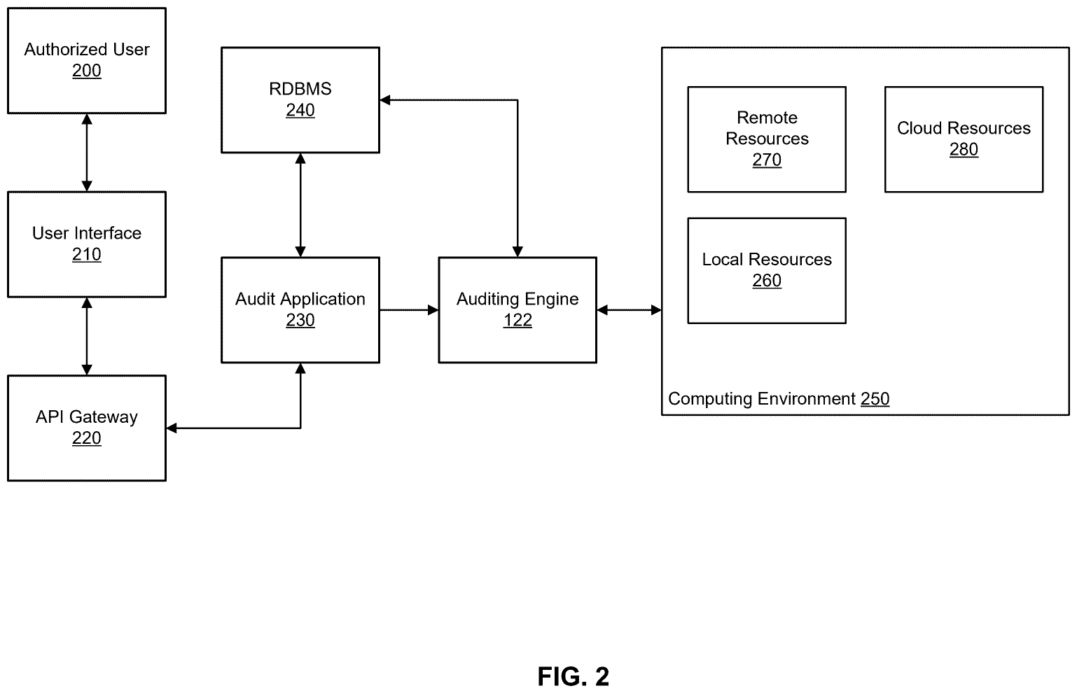

FIG. 2 is a high-level representation of data flow between various components of the present invention, according to some embodiments. In various embodiments, authorized user 200 executes audit application 230 via user interface 210 and Application Programming Interface (API) gateway 220. Based on information received from audit application 230, auditing engine 122 may query one or more computing resources included in computing environment 250, such as local resources 260, remote resources 270, or cloud resources 280. Auditing engine 122 may generate one or more audit reports based on the specified audit types and query results received from the one or more computing resources. A relational database management system (RDBMS) 240 may store configuration information describing computing environment 250 and transmit the configuration information to auditing engine 122. RDBMS 240 may also store the audit reports generated by auditing engine 122.

Authorized user 200 may include a human user or an upstream software application. In various embodiments, authorized user 200 may initiate one or more audits or view the results of one or more audits initiated by authorized user 200. Authorized user 200 may have an associated user identifier (USERID) and possess one or more associated user permissions. The one or more user permissions may be associated with the user's account on computing environment 250, or may be explicitly granted to the user via delegation by a different user. In various embodiments, the one or more user permissions may also be based on a role associated with the user, or a user group to which the user belongs. Authorized user 200 may submit an audit request via user interface 210.

User interface 210 may include a text-based or graphical user interface presented to authorized user 200 via one or more of I/O devices 108, such as a computer display. In various embodiments, user interface 210 may include a dedicated user interface configured to communicate with audit application 230 described below. In other embodiments, user interface 210 may be incorporated into an existing messaging platform or an existing observation/monitoring platform. In embodiments where user interface 210 is incorporated into an existing messaging or observation/monitoring platform, user interface 210 may communicate with audit application 230 via Application Programming Interface (API) gateway 220. Various embodiments of the present invention may include multiple instances of user interface 210 and allow simultaneous interaction with multiple authorized users 200.

In embodiments that include API gateway 220, API gateway 220 may specify one or more interface formats or standards allowing user interface 210 to communicate with audit application 230. In various embodiments that do not include API gateway 220, user interface 210 may include necessary interface formats or standards allowing user interface 210 to communicate directly with audit application 230.

Audit application 230 receives an audit request from user interface 210, either directly or via API gateway 220. The audit request may include a user identifier (USERID) associated with authorized user 200. The audit request may also include a business application identifier (BAPPID). The BAPPID uniquely identifies one of multiple business software applications included in an organization's computing environment 250 described below. The term “business software applications” refers broadly to any software applications resident in or executed on one or more computing resources included in an organization's computing environment 250, and is not intended to limit or characterize the type or function of a software application. The audit request may further include an audit type associated with the audit request. Examples of audit types include Sarbanes-Oxley (SOX), Payment Card Industry (PCI), or Health Insurance Portability and Accountability (HIPAA). Audit application 230 may also one or more authorizations and/or permissions associated with authorized user 200. In various embodiments, audit application 230 may retrieve the USERID, the one or more authorizations, or the one or more permissions from relational database management system (RDBMS) 240 described below. Audit application 230 transmits the USERID, BAPPID, and audit type associated with the audit request to auditing engine 122.

Auditing engine 122 performs an audit of one or more computing resources included in computing environment 250, based on data received from audit application 230 and associated with an audit request generated by authorized user 200. In various embodiments, auditing engine 122 may query one or more computing resources included in computing environment based on the received data associated with the audit request. For example, given a USERID and permissions and authorizations associated with the USERID, auditing engine 122 may query one or more computing resources associated with a BAPPID included in the audit request. In response to the query, each of the one or more computing resources may return a list of users belonging to the organization and associated with one or more of the computing resources and the business software application specified by the BAPPID included in the audit request. Auditing engine 122 may generate one or more audit reports based on the query results. Auditing engine 122 may transmit the query reports to authorized user 200 via user interface 210. Additionally or alternatively, auditing engine 122 may store the generated audit reports in RDBMS 240.

Computing environment 250 includes one or more computing resources associated with an organization. In various embodiments, the computing resources may include one or more of local resources 260, remote resources 270, or cloud resources 280. Local resources 260 may include computing resources maintained by the organization and situated geographically close to auditing engine 122, e.g., on the same computing resource as auditing engine 122 or in the same building as auditing engine 122. Auditing engine 122 may communicate with local resources 260 over a local area network (LAN), such as a LAN included in network 110. Remote resources 270 may include computing resources maintained by the organization and situated in a location that is geographically remote from auditing engine 122, such as computing resources located in a different building than auditing engine 122. Auditing engine 122 may communicate with remote resources 270 via a LAN, a wide area network (WAN), Wi-Fi, or the Internet. Cloud resources 280 may include computing resources that are maintained by a third party and situated in a geographically remote location from auditing engine 122. Cloud resources 280 may include remote processing services and/or storage capabilities. Auditing engine 122 may communicate with cloud resources 280 via any suitable network, such as the Internet.

In various embodiments, one or more of local resources 260, remote resources 270, or cloud resources 280 may include dedicated hardware storage and processing capabilities. Alternatively, one or more of local resources 260, remote resources 270, or cloud resources 280 may be implemented as a virtual machine or virtual storage on a shared computing resource.

RDBMS 240 includes a relational database management system that stores information associated with one or more authorized users 200, one or more computing resources included in computing environment 250, or one or more audit reports generated by auditing engine 122. In various embodiments, RDBMS 240 may include configuration information associated with computing environment 250, such as a list of multiple instances of computing resources 260, 270, or 280, or a list of business software applications resident on each of multiple instances of computing resources 260, 270, or 280. RDBMS 240 may retrieve the list of business software applications and associated computing resources 260, 270, or 280 from an application deployment management tool (not shown). The application deployment management tool may associate the unique BAPPID for a particular business software application with one or more instances of computing resources 260, 270, or 280 on which an instance of the business software application resides. RDBMS 240 may also include permission and/or authorization data associated with one or more authorized users 200. RDBMS 240 may further store audit reports generated by auditing engine 122 for subsequent retrieval, display, or analysis.

In various embodiments, one or more additional software applications (not shown) may update the configuration information associated with computing environment 250 and stored in RDBMS 240. For example, the one or more additional software applications may traverse computing environment 250 and update RDBMS 240 with computing resources, users, and/or business software applications recorded during the traversal. RDBMS 240 may be updated on a periodic basis, e.g., daily or weekly, or may be updated based on the receipt of a new audit request. RDBMS 240 may also be updated manually or automatically upon the installation, removal, upgrade, degradation, or failure of a computing resource included in computing environment 250.

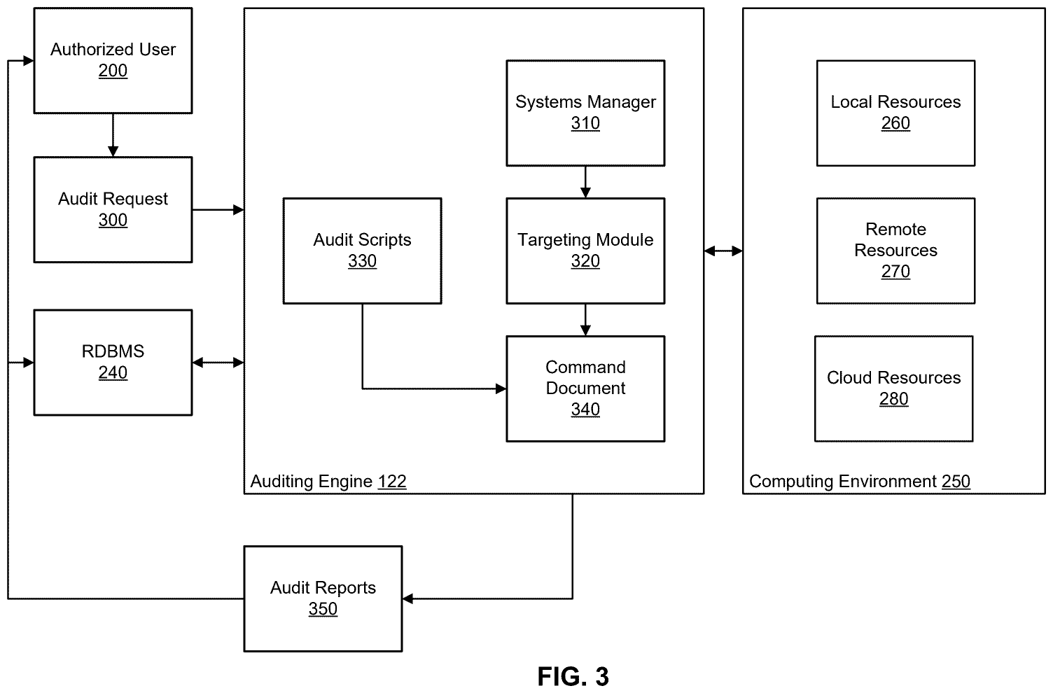

FIG. 3 is a more detailed illustration of auditing engine 122 of FIGS. 1 and 2, according to some embodiments. Auditing engine 122 performs an audit of one or more computing resources included in computing environment 250 based on at least a USERID, BAPPID, and audit type included in an audit request 300 received from authorized user 200 via user interface 210. Auditing engine 122 generates one or more audit reports and transmits the generated audit reports to one or more of user interface 210 and RDBMS 240. Auditing engine 122 includes, without limitation, audit scripts 330, systems manager 310, targeting module 320, and command document 340.

Auditing engine 122 receives an audit request 300 from authorized user 200 via user interface 210. In various embodiments, audit request 300 includes a unique user identifier (USERID) associated with authorized user 200. Audit request 300 may also include a unique business application identifier (BAPPID) associated with a software application included in computing environment 250. Audit request 300 may also include a specified audit type, such as SOX, PCI, or HIPAA. Auditing engine 122 may generate a unique job identifier (JOBID) associated with audit request 300 and associate the JOBID with the USERID.

In various embodiments, auditing engine 122 may retrieve permission or authorization information associated with a user having the USERID included in audit request 300. As discussed above in the description of FIG. 2, the user permission or authorization information may reside in RDBMS 240. The permission or authorization information may include passwords, authentication or authorization tokens, or details of a user's organizational roles or user group memberships.

Audit scripts 330 may include one or more audit scripts, where each audit script defines data collection requirements associated with a particular audit type. For example, an audit script may specify that, for each computing resource included in computing environment 250, auditing engine 122 is to retrieve a list of users associated with both the computing resource and a business software application associated with the BAPPID included in audit request 300. An audit script may also instruct auditing engine 122 to retrieve data from one or more computing resources describing the storage and/or processing capabilities of the computing resource, a vendor associated with the computing resource, model information associated with the computing resource, or a status associated with the computing resource. Auditing engine 122 transmits audit scripts 330 to command document 340 described below.

Systems manager 310 stores configuration data associated with computing environment 250. In some embodiments, the configuration data may include a list of one or more computing resources included in local resources 260, remote resources 270, or cloud resources 280, along with local, remote, or internet address information for each of the one or more computing resources.

Targeting module 320 determines a list of computing resources for auditing engine 122 to query, based on the information included in systems manager 310, RDBMS 240, and audit scripts 330. For example, targeting module 320 may generate a list of computing resources to query based on an audit type received via user interface 210 and definitions specified by an audit script included in audit scripts 330. Specifically, targeting module 320 may retrieve a list from RDBMS 240 that includes one or more computing resources that host the business software application associated with the BAPPID included in the audit request. Targeting module 320 may generate a list including all or a subset of local resources 260, remote resources 270, or cloud resources 280 included in computing environment 250. Auditing engine 122 transmits the generated list to command document 340.

Command document 340 may include instructions for accessing and querying computing resources included in computing environment 250, based on the list of computing resources generated by targeting module 320 and one or more scripts included in audit scripts 330. In various embodiments, the instructions included in command document 340 may be expressed in an executable scripting or programming language. Command document 340 may process an audit script selected from audit scripts 330 based on an audit type included in audit request 300, the list of computing resources generated by targeting module 320, and the BAPPID included in the audit request. For each computing resource included in the list of computing resources to be queried, command document 340 generates a corresponding query that is based on the audit script selected from audit scripts 330 and tailored to the query requirements of the particular computing resource to be queried. For example, each computing resource included in local resources 260, remote resources 270, or cloud resources 280 may have different interface requirements, query formats, or formatting standards. Command document 340 may also include one or more APIs to enable querying the computing resources included in computing environment 250.

Auditing engine 122 performs one or more queries against computing resources included in computing environment 250, based on the audit script selected from audit scripts 330 and the instructions included in command document 340. Auditing engine 122 may associate each query and corresponding query results with the JOBID associated with audit request 300. Associating queries and query results with a particular JOBID allows auditing engine 122 to aggregate multiple query results and associate the aggregated results with audit request 300 associated with the JOBID. In response to a query, auditing engine 122 may receive an indication that the query could not be completed successfully. For example, a computing resource included in computing environment 250 may be offline or otherwise unavailable, or the permissions and/or authorizations associated with a requesting authorized user 200 may be insufficient. Auditing engine 122 records the unsuccessful query results and any associated errors for inclusion in audit reports 350 described below.

In various embodiments, auditing engine 122 is operable to process multiple audit requests 300 simultaneously, or to simultaneously execute multiple queries against different computing resources included in computing environment 250. Auditing engine 122 may simultaneously process multiple audit requests 300 or simultaneously execute multiple queries via known multitasking or multithreading techniques. Various embodiments of the present invention may also include multiple instances of auditing engine 122, where each instance of auditing engine 122 is operable to process multiple audit requests 300 or query multiple computing resource simultaneously. Via simultaneous execution of multiple audit requests and/or computing resource queries, the present invention is scalable to perform audit orchestration beyond what is possible via manual orchestration and is operable to orchestrate audits in an enterprise computing environment 250 having thousands or tens of thousands of users, computing resources, and/or business software applications.

Auditing engine 122 generates one or more audit reports 350 based on the query results received from computing resources included in computing environment 250. For example, an audit report 350 may include a listing of one or more computing resources included in computing environment that host a business software application specified by a BAPPID included in audit request 300. For each of the one or more computing resources included in the listing, the listing may further include a roster of one or more users associated with the computing resource. In various embodiments, each of one or more audit reports 350 may include an indication that auditing engine 122 successfully executed the one or more scripts selected from audit scripts 330. If one or more of the audit scripts selected from audit scripts 330 were not executed successfully, the one or more audit reports 350 may include a description of one or more failure conditions. For example, a computing resource included in computing environment 250 may be offline or otherwise unavailable, or the permissions and/or authorizations associated with a requesting authorized user 200 may be insufficient. In various embodiments, auditing engine 122 may automatically re-attempt one or more failed computing resource queries. Auditing engine 122 may generate an alert based on the one or more failure conditions, where the alert includes one or more suggestions for rectifying a failure condition. Auditing engine 122 may also transmit an audit report 350, including a description of one or more failure conditions, to a human reviewer or downstream software application for further review or analysis

Audit reports 350 may include multiple separate audit reports, with each audit report associated with a different audit type included in audit request 300. An audit report included in audit reports 350 may also include the JOBID associated with audit request 300, the audit type(s) included in audit request 300, one or more BAPPIDs included in audit request 300, and/or a USERID associated with the user or upstream software application that submitted audit request 300.

Auditing engine 122 may store the one or more generated audit reports 350 in RDBMS 240 for subsequent retrieval, display, or analysis. Auditing engine 122 may also transmit the one or more generated audit reports to user interface 210 for display via, e.g., I/O devices 108. Because each of audit reports 350 includes an associated JOBID that is correlated to a user having a specific USERID, the present invention is operable to restrict the viewing, retrieval, or analysis of audit reports 350 to the user having the USERID associated with a particular audit result. The authorized user 200 who initiated audit request 300 may delegate viewing, retrieval, or analysis authority to a different user, and a user having an administrative role within an organization or computing environment 250 may be able to view, retrieve, or analyze any of audit reports 350, regardless of which user or upstream software application submitted audit request 300 causing auditing engine 122 to generate audit reports 350.

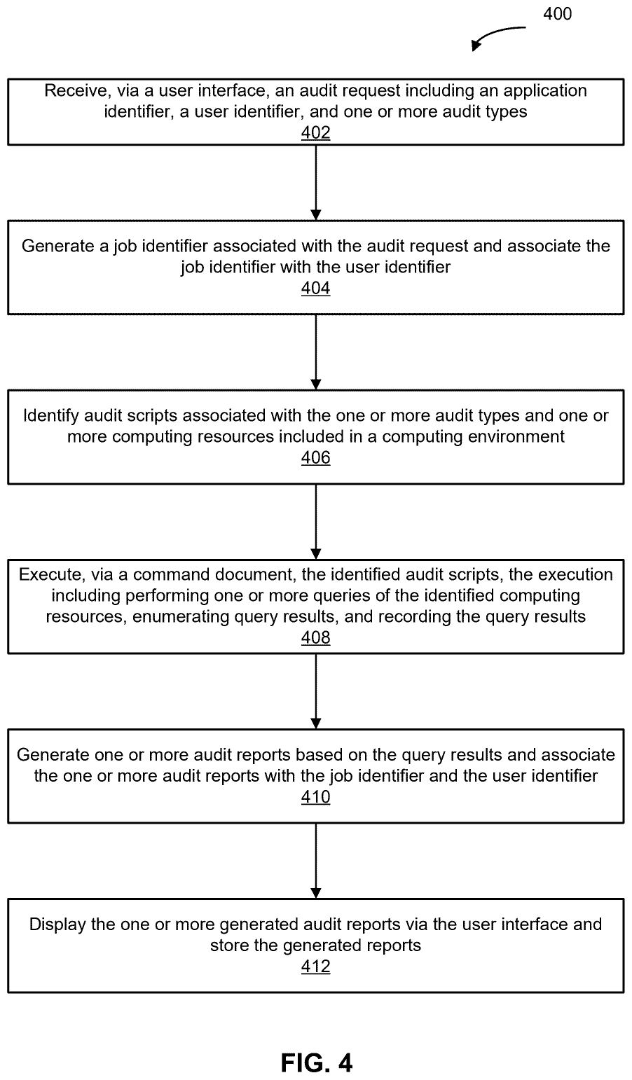

FIG. 4 is a flow diagram of method steps for performing user audit orchestration, according to some embodiments. Although the method steps are described in conjunction with the systems of FIGS. 1 and 3, persons skilled in the art will understand that any system configured to perform the method steps in any order falls within the scope of the present disclosure.

As shown, in step 402 of method 400, auditing engine 122 receives, via user interface 210, audit request 300 from an authorized user 200 including a business application identifier (BAPPID), a user identifier (USERID), and one or more audit types. For example, the one or more audit types may include Sarbanes-Oxley (SOX), Payment Card Industry (PCI), or Health Insurance Portability and Accountability (HIPAA).

In step 404, auditing engine 122 generates a unique job identifier (JOBID) associated with audit request 300, and associates the JOBID with the USERID included in audit request 300. In various embodiments, auditing engine 122 associates generated audit results with the unique JOBID. Auditing engine 122 may retrieve authorization and/or permission information based on the USERID associated with the JOBID.

In step 406, auditing engine 122 identifies one or more audit scripts included in audit scripts 330, based on the one or more audit types included in audit request 300. Each of the one or more audit scripts 330 may include one or more audit scripts, where each audit script defines data collection requirements associated with a particular audit type. For example, an audit script may specify that, for each computing resource included in computing environment 250, auditing engine 122 is to retrieve a list of users associated with both the computing resource and a business software application associated with the BAPPID included in audit request 300. An audit script may also instruct auditing engine 122 to retrieve data from one or more computing resources describing the storage and/or processing capabilities of the computing resource, a vendor associated with the computing resource, model information associated with the computing resource, or a status associated with the computing resource.

Auditing engine 122 may also identify, via targeting module 320, one or more computing resources included in computing environment 250. For example, targeting module 320 may generate a list of computing resources to query, based on an audit type received via user interface 210 and definitions specified by an audit script included in audit scripts 330. Targeting module 320 may generate a list including all or a subset of local resources 260, remote resources 270, or cloud resources 280 included in computing environment 250. In various embodiments, targeting module 320 may generate an infrastructure map describing computing environment 250. The infrastructure map may be based at least on computing resource configuration information stored RDBMS 240. The infrastructure map may include a graph depicting a hierarchical arrangement of computing resources 260, 270, or 280, including one or more platforms, environments, user accounts, geographical regions, or computing resource endpoints associated with computing environment 250.

In step 408, auditing engine 122 executes, via command document 340, the identified one or more audit scripts included in audit scripts 330, where the execution includes performing one or more queries of the computing resources identified via targeting module 320. Command document 340 may include instructions for accessing and querying computing resources included in computing environment 250, based on the list of computing resources generated by targeting module 320 and one or more scripts included in audit scripts 330. In various embodiments, the instructions included in command document 340 may be expressed in an executable scripting or programming language. Command document 340 may process an audit script selected from audit scripts 330 based on an audit type included in audit request 300 and the list of computing resources generated by targeting module 320. For each computing resource included in the list of computing resources to be queried, command document 340 generates a corresponding query that is based on the audit script selected from audit scripts 330 and tailored to the query requirements of the particular computing resource to be queried. Auditing engine 122 receives query results from the one or more queries and associates the query results with the JOBID for audit request 300.

In step 410, auditing engine 122 generates one or more audit reports 350 based on the received query results. Auditing engine 122 associates each of the one or more audit reports 350 with the JOBID and USERID included in or associated with audit request 300. In various embodiments, each of one or more audit reports 350 may include an indication that auditing engine 122 successfully executed the one or more scripts selected from audit scripts 330. If one or more of the audit scripts selected from audit scripts 330 were not executed successfully, the one or more audit reports 350 may include a description of one or more failure conditions. For example, a computing resource included in computing environment 250 may be offline or otherwise unavailable, or the permissions and/or authorizations associated with a requesting authorized user 200 may be insufficient. In various embodiments, auditing engine 122 may automatically re-attempt one or more failed computing resource queries. Auditing engine 122 may generate an alert based on the one or more failure conditions, where the alert may include one or more suggestions for rectifying a failure condition. Auditing engine 122 may also transmit an audit report 350, including a description of one or more failure conditions, to a human reviewer or downstream software application for further review or analysis

In step 412, auditing engine 122 may store the generated one or more audit reports 350 in relational database management system (RDBMS) 240 for subsequent retrieval, display, or analysis. In various embodiments, the present invention may restrict the retrieval, display, or analysis of the generated one or more audit reports 350 to the user associated with the USERID included in the audit report. Generated audit reports 350 may also be retrieved, displayed, or analyzed by a different user having authority or permission delegated from the user associated with the USERID included in the audit report, or by a different user having an administrative role within the organization. Alternatively or additionally, auditing engine 122 may transmit the one or more audit reports 350 directly to user interface 210 for display. Similar to stored audit reports 350, the present invention may restrict the display of generated audit reports 350 via interface 210 to the user having the USERID included in audit request 300, a different user having authority or permission delegated from the user having the USERID included in audit request 300, or a different user having an administrative role within the organization.

Various embodiments of the present invention may be operable to process multiple audit requests 300 simultaneously, including executing multiple simultaneous queries against one or more computing resources included in computing environment 250. These embodiments may include multiple instances of user interface 210 and auditing engine 122, where each instance of auditing engine 122 processes a different audit request 300. A single instance of auditing engine 122 may also be operable to execute multiple simultaneous queries against one or more computing resources included in computing environment 250 via multitasking or multithreading techniques. One or more instances of auditing engine 122 may associate scripts selected from audit scripts 330, computing resources identified by targeting module 320, and received query results with the JOBID associated with audit request 300, allowing auditing engine 122 to aggregate audit results from multiple threads within a single instance of auditing engine 122 or from multiple instances of auditing engine 122. Accordingly, multiple instances of each of steps 402, 404, 406, 408, 410, and 412 of method 400 may execute simultaneously during the processing of multiple simultaneous audit requests 300. Similarly, during the processing of a single audit request 300, multiple instances of step 408 of method 400 may execute simultaneously as auditing engine 122 performs parallel queries of multiple computing resources. Via simultaneous execution of multiple audit requests and/or computing resource queries, the present invention is scalable to perform audit orchestration beyond what is possible via manual orchestration and is operable to orchestrate audits in an enterprise computing environment 250 having thousands or tens of thousands of users, computing resources, and/or business software applications.

In sum, the disclosed techniques perform user audit orchestration based on a specified business application and one or more audit types, such as Sarbanes-Oxley (SOX), Payment Card Industry (PCI), or Health Insurance Portability and Accountability (HIPAA). In various embodiments, the disclosed techniques identify one or more computing resources included in an enterprise computing environment and associated with the specified business application. The techniques query the identified computing resources and generate one or more reports including at least a list of user accounts associated with the computing resources. The disclosed techniques may store the generated report(s) and/or transmit the generated report(s) to an I/O device for display.

In operation, an auditing engine receives an audit request via a user interface from a user or upstream software application. The audit request may include a user identifier (USERID), one or more audit types, and a business application program identifier (BAPPID). The auditing engine generates a job identifier (JOBID) associated with the audit request and the USERID.

The auditing engine selects one or more audit scripts based on the one or more input audit types. Based on system configuration information stored in a relational database management system (RDBMS), the auditing engine identifies one or more computing resources included in an enterprise computing environment. The one or more computing resources may include local resources situated on the same location as the auditing engine. The one or more computer resources may also include remote resources that are part of an organization's computing environment and geographically separated from the auditing engine, or cloud computing resources associated with the organization, e.g. subscription-based computing resources.

The auditing engine queries the one or more identified computing resources based on instructions included in the one or more audit scripts. For example, the auditing engine may query the identified computing resources for a list of user accounts associated with the computing resource and the specified business application program. The auditing engine includes a command document that provides necessary conversion and/or translation capabilities between the one or more selected audit scripts and the one or more identified computing resources. For example, the command document may include instructions for querying a particular computing resource based on the type of computing resource, e.g., local, remote, or cloud. The command document may further include instructions for querying a particular computing resource based on a particular provider associated with the computing resource, such as a specific cloud computing resource provider.

The auditing engine generates one or more audit reports based on the specified audit types, the identified computing resources, and the information retrieved from the computing resources based on the submitted queries. The auditing engine may store the generated audit reports in, e.g., the RDBMS and/or transmit the generated audit reports to the user interface for display via one or more input/output (I/O) devices, such as a graphical display. The auditing engine may associate the generated audit reports with a USERID submitted with the audit request and/or a JOBID associated with the audit request, such that the generated audit reports may only be accessed or viewed by the user associated with the audit request.

The auditing engine may process one or more audit requests in parallel, via multitasking or multithreading techniques, or via the simultaneous execution of multiple instances of the auditing engine. In addition, the auditing engine may perform simultaneous queries against multiple computing resources included in the computing environment. The auditing engine tracks multiple audit requests and/or multiple computing resource queries via the USERIDs and JOBIDs associated with the audit requests or computing resource queries.

One technical advantage of the disclosed techniques relative to the prior art is that the disclosed techniques may perform automated user audit orchestration across a variety of disparate computing resources included in an organization's computing environment. The disclosed techniques may further orchestrate multiple user audits or computing resource queries in parallel. These technical advantages provide one or more improvements over prior art approaches.

1. In some embodiments, a computer-implemented method for performing user audit orchestration, the computer-implemented method comprises receiving an audit request including at least an application identifier associated with a software application, identifying a plurality of computing resources associated with the application identifier, executing multiple simultaneous queries of the plurality of computing resources, aggregating results of the multiple simultaneous queries, and generating one or more audit reports based on the aggregated query results of the multiple simultaneous queries.

2. The computer-implemented method of clause 1, wherein the audit request further includes one or more audit types and a user identifier.

3. The computer-implemented method of clauses 1 or 2, wherein the one or more audit types include Sarbanes-Oxley (SOX), Payment Card Industry (PCI), or Health Insurance Portability and Accountability (HIPAA).

4. The computer-implemented method of any of clauses 1-3, wherein executing the multiple simultaneous queries is based on one or more permissions or authorizations associated with the user identifier.

5. The computer-implemented method of any of clauses 1-4, wherein the aggregated query results include a listing of one or more users associated with the software application.

6. The computer-implemented method of any of clauses 1-5, wherein the multiple simultaneous queries are based at least on one or more audit scripts.

7. The computer-implemented method of any of clauses 1-6, wherein the plurality of computing resources one or more of local computing resources, remote computing resources, or cloud computing resources.

8. The computer-implemented method of any of clauses 1-7, wherein aggregating the results of the multiple simultaneous queries is based on a job identifier associated with the audit request.

9. The computer-implemented method of any of clauses 1-8, wherein the multiple simultaneous queries are executed based on a command document that includes one or more of a query format or an interface requirement associated with a computing resource.

10. The computer-implemented method of any of clauses 1-9, wherein each of the one or more audit reports includes a user identifier, an application identifier, and a job identifier.

11. In some embodiments, one or more non-transitory computer-readable media store instructions that, when executed by one or more processors, cause the one or more processors to perform the steps of receiving an audit request including at least an application identifier associated with a software application, identifying a plurality of computing resources associated with the application identifier, executing multiple simultaneous queries of the plurality of computing resources, aggregating results of the multiple simultaneous queries, and generating one or more audit reports based on the aggregated query results of the multiple simultaneous queries.

12. The one or more non-transitory computer-readable media of clause 11, wherein the audit request further includes one or more audit types and a user identifier.

13. The one or more non-transitory computer-readable media of clauses 11 or 12, wherein executing the multiple simultaneous queries is based on one or more permissions or authorizations associated with the user identifier.

14. The one or more non-transitory computer-readable media of any of clauses 11-13, wherein the aggregated query results include a listing of one or more users associated with the software application.

15. The one or more non-transitory computer-readable media of any of clauses 11-14, wherein the multiple simultaneous queries are based at least on one or more audit scripts.

16. The one or more non-transitory computer-readable media of any of clauses 11-15, wherein aggregating the results of the multiple simultaneous queries is based on a job identifier associated with the audit request.

17. The one or more non-transitory computer-readable media of any of clauses 11-16, wherein the multiple simultaneous queries are executed based on a command document that includes one or more of a query format or an interface requirement associated with a computing resource.

18. The one or more non-transitory computer-readable media of any of clauses 11-17, wherein each of the one or more audit reports includes a user identifier, an application identifier, and a job identifier.

19. In some embodiments, a system comprises one or more memories storing instructions, and one or more processors for executing the instructions to receive an audit request including at least an application identifier associated with a software application, identify a plurality of computing resources associated with the application identifier, execute multiple simultaneous queries of the plurality of computing resources, aggregate results of the multiple simultaneous queries, and generate one or more audit reports based on the aggregated query results of the multiple simultaneous queries.

20. The system of clause 19, wherein the aggregated query results include a listing of one or more users associated with the software application.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing user audit orchestration, the computer-implemented method comprising:
receiving an audit request including at least an application identifier associated with a software application;
identifying a plurality of computing resources associated with the application identifier;
executing multiple simultaneous queries of the plurality of computing resources;
aggregating results of the multiple simultaneous queries; and
generating one or more audit reports based on the aggregated query results of the multiple simultaneous queries.

2. The computer-implemented method of claim 1, wherein the audit request further includes one or more audit types and a user identifier.

3. The computer-implemented method of claim 2, wherein the one or more audit types include Sarbanes-Oxley (SOX), Payment Card Industry (PCI), or Health Insurance Portability and Accountability (HIPAA).

4. The computer-implemented method of claim 2, wherein executing the multiple simultaneous queries is based on one or more permissions or authorizations associated with the user identifier.

5. The computer-implemented method of claim 1, wherein the aggregated query results include a listing of one or more users associated with the software application.

6. The computer-implemented method of claim 1, wherein the multiple simultaneous queries are based at least on one or more audit scripts.

7. The computer-implemented method of claim 1, wherein the plurality of computing resources one or more of local computing resources, remote computing resources, or cloud computing resources.

8. The computer-implemented method of claim 1, wherein aggregating the results of the multiple simultaneous queries is based on a job identifier associated with the audit request.

9. The computer-implemented method of claim 1, wherein the multiple simultaneous queries are executed based on a command document that includes one or more of a query format or an interface requirement associated with a computing resource.

10. The computer-implemented method of claim 1, wherein each of the one or more audit reports includes a user identifier, an application identifier, and a job identifier.

11. One or more non-transitory computer-readable media storing instructions that, when executed by one or more processors, cause the one or more processors to perform the steps of:
receiving an audit request including at least an application identifier associated with a software application;
identifying a plurality of computing resources associated with the application identifier;
executing multiple simultaneous queries of the plurality of computing resources;
aggregating results of the multiple simultaneous queries; and
generating one or more audit reports based on the aggregated query results of the multiple simultaneous queries.

12. The one or more non-transitory computer-readable media of claim 11, wherein the audit request further includes one or more audit types and a user identifier.

13. The one or more non-transitory computer-readable media of claim 12, wherein executing the multiple simultaneous queries is based on one or more permissions or authorizations associated with the user identifier.

14. The one or more non-transitory computer-readable media of claim 11, wherein the aggregated query results include a listing of one or more users associated with the software application.

15. The one or more non-transitory computer-readable media of claim 11, wherein the multiple simultaneous queries are based at least on one or more audit scripts.

16. The one or more non-transitory computer-readable media of claim 11, wherein aggregating the results of the multiple simultaneous queries is based on a job identifier associated with the audit request.

17. The one or more non-transitory computer-readable media of claim 11, wherein the multiple simultaneous queries are executed based on a command document that includes one or more of a query format or an interface requirement associated with a computing resource.

18. The one or more non-transitory computer-readable media of claim 11, wherein each of the one or more audit reports includes a user identifier, an application identifier, and a job identifier.

19. A system comprising:
one or more memories storing instructions; and
one or more processors for executing the instructions to:
receive an audit request including at least an application identifier associated with a software application;
identify a plurality of computing resources associated with the application identifier;
execute multiple simultaneous queries of the plurality of computing resources;
aggregate results of the multiple simultaneous queries; and
generate one or more audit reports based on the aggregated query results of the multiple simultaneous queries.

20. The system of claim 19, wherein the aggregated query results include a listing of one or more users associated with the software application.
